(19) United States
(12) Patent Application Publication
(10) Pub. No.: US 2026/0200117 A1
(43) Pub. Date: Jul. 16, 2026

(54) PAPERBOARD CUTTING DEVICE AND PAPERBOARD CUTTING SYSTEM

(71) Applicant: Shenzhen Little Beaver Technology Co., Ltd, Shenzhen (CN)

(72) Inventors: Rem LIN, Shenzhen (CN); Ethan WANG, Shenzhen (CN)

(73) Assignee: Shenzhen Little Beaver Technology Co., Ltd, Shenzhen (CN)

(21) Appl. No.: 19/559,989

(22) Filed: Mar. 7, 2026

Related U.S. Application Data
(63) Continuation of application No. PCT/CN2025/083027, filed on Mar. 17, 2025.

(30) Foreign Application Priority Data
Oct. 21, 2024 (CN) 202422543626.9

(51) Int. Cl. B26D 7/22; B26D 1/00; B26D 1/10

(52) U.S. Cl. CPC B26D 7/22; B26D 1/0006; B26D 1/105; B26D 2001/0013

(57) ABSTRACT

A paperboard cutting device includes a driving component; a linear transmission mechanism, wherein the driving component is drivably connected to an input portion of the linear transmission mechanism; a cutter bar component fixedly mounted on an output portion of the linear transmission mechanism; a housing component having a housing inner cavity; and a protection component disposed on a cutting station surface of the housing component. The protection component has a protection cover above the cutting station surface of the housing component, and a station space is defined between the cutting station surface and the protection cover. The cutter bar component, the driving component, and the linear transmission mechanism are mounted inside the housing inner cavity.

### CROSS-REFERENCE TO RELATED APPLICATIONS

This application is a continuation application of International Application No. PCT/CN2025/083027, filed on March 17, 2025, which claims priorities to Chinese Patent Application No. 202422543626.9, filed with the Chinese Patent Office on October 21, 2024, the entire contents of which are incorporated herein by reference.

### TECHNICAL FIELD

The present disclosure relates to the field of cutting technologies, and in particular, to a paperboard cutting device and a paperboard cutting system.

### BACKGROUND

At present, most paperboard cutting devices are configured for industrial or professional use. In order to ensure the efficiency, precision and degree of automation of paperboard cutting, the conventional paperboard cutting devices generally integrate various mechanical components with control systems. That is, the conventional paperboard cutting device may include a cutting machine body, a roller system, a power system, a cutting assembly, a control system, and a cutting tool movement system, which not only can result in a complicated structure, and cumbersome operation, but also can increase the overall size of the machine, making the paperboard cutting device less suitable for children to use. In addition, there may be safety concerns. Some conventional cutting tools (such as scissors, etc.) for children are manually operated, and these tools not only may fail to effectively cut thicker paperboard, leading to a poor user experience, but also may pose a risk of accidental finger laceration from the cutting tools.

### SUMMARY

In order to overcome at least one of the defects in the related art, the present disclosure provides a paperboard cutting device and a paperboard cutting system, which addresses the problems that a child may be unable to cut a thicker paperboard with a conventional cutting tool, and helps ensure the safety of the child during the process of cutting the paperboard.

The technical solution adopted by the present disclosure to solve the problems is as follows.

A paperboard cutting device including:

a driving component;

a linear transmission mechanism, where the driving component is drivably connected to an input portion of the linear transmission mechanism;

a cutter bar component, fixedly mounted on an output portion of the linear transmission mechanism; and

a housing component having a housing inner cavity is disposed inside the housing component, wherein an outer top surface of a housing top wall is configured as a cutting station surface; and

a protection component disposed on the cutting station surface are disposed on the housing component, wherein the protection component includes a protection base and a protection cover, wherein the protection base includes a cutter bar through hole, and is positioned on a top housing wall of the housing component, and wherein the protection cover has an upper surface and a lower surface, and is arranged outside the housing component and above the cutting station surface, wherein a station space is defined between the cutting station surface and the lower surface of the protection cover;

wherein the cutter bar component, the driving component, and the linear transmission mechanism are all mounted in the housing inner cavity;

wherein the cutter bar component passes through the protection component, and a cutting edge end of the cutter bar component is driven by the linear transmission mechanism to protrude from the protection component and extend into the station space, as well as to reset and retract back to an inside of the protection component.

In some embodiments of the present disclosure, the protection cover is connected to the protection base, the protection base is fixedly connected to the housing component, and the cutter bar component passes through the protection base.

In some embodiments of the present disclosure, the protection component further includes a protection connector, the protection connector is disposed at a side of the cutter bar component, and the protection cover is connected to the protection base through the protection connector, wherein the protection connector includes a replaceable support sleeve disposed between the protection cover and the protection base and a connecting fastener, and wherein a height of the replaceable support sleeve defines a cutting thickness of the station space.

In some embodiments of the present disclosure, a side of the cutter bar component close to the station space is configured with a cutting surface, and a peripheral edge of the cutting surface is configured as the cutting edge end of the cutter bar component; and

the cutter bar component is driven by the linear transmission mechanism to translate relative to the protection base along a central axis direction of the cutter bar component, so that the cutting surface is offset from the cutting station surface for cutting a paperboard.

In some embodiments of the present disclosure, along a central axis direction of the cutter bar component, a distance between the cutting station surface and the protection component is defined as a cutting thickness H of the station space, and the cutting thickness H ranges from 1.5 mm to 3 mm.

In some embodiments of the present disclosure, along a central axis direction of the cutter bar component, the protection cover is provided with a cutter positioning space, and when the cutter bar component extends into the station space, the cutting edge end of the cutter bar component is inserted into the cutter positioning space.

In some embodiments of the present disclosure, the protection component further includes a protection shell disposed around an outer side of the protection cover, the protection shell is provided with a feed conveying port communicated with the station space, and along a central axis direction of the cutter bar component, a distance between the cutting station surface and the protection component is greater than or equal to a width of the feed conveying port.

In some embodiments of the present disclosure, the linear transmission mechanism includes a push rod member, the push rod member serves as the output portion of the linear transmission mechanism, the cutter bar component is fixedly connected to the push rod member, and the push rod member is drivably connected to a driving end of the driving component.

In some embodiments of the present disclosure, the linear transmission mechanism further includes a transmission component, the transmission component is drivably connected to the push rod member, and the transmission component is detachably connected to the driving end of the driving component.

In some embodiments of the present disclosure, the push rod member includes a transmission inner cavity, and the transmission component is mounted in the transmission inner cavity.

In some embodiments of the present disclosure, the transmission component comprises a cam member, the cam member serves as the input portion of the linear transmission mechanism, a circumferential curved surface of the cam member abuts against a first inner cavity surface of the transmission inner cavity, the first inner cavity surface is a side surface of the transmission inner cavity close to the cutter bar component, and the cam member is connected to the driving component.

In some embodiments of the present disclosure, the transmission component includes a crank member and a connecting rod member, the crank member serves as the input portion of the linear transmission mechanism, the crank member is connected to the push rod member through the connecting rod member, and the crank member is connected to the driving component.

In some embodiments of the present disclosure, the transmission component includes a rotating body member and a translating body member, the translating body member is engaged with or meshed with the rotating body member, the rotating body member serves as the input portion of the linear transmission mechanism, the translating body member is connected to the push rod member, and the translating body member is connected to the driving component.

In some embodiments of the present disclosure, the linear transmission mechanism further includes a guide component, a direction of movement guided by the guide component is consistent with a central axis direction of the cutter bar component, the push rod member is slidably connected to the guide component, and the guide component is fixedly connected to the housing component.

In some embodiments of the present disclosure, the guide component includes a first guide member and a second guide member, the second guide member is provided with a guide hole into which the first guide member is inserted, an extension direction of the first guide member is consistent with the central axis direction of the cutter bar component, and the first guide member and the second guide member are slidably connected with each other; and

one of the first guide member and the second guide member is disposed on the push rod member, and another one of the first guide member and the second guide member is disposed on the housing component.

In some embodiments of the present disclosure, the paperboard cutting device further includes a coupling, and the transmission component is connected to the driving end of the driving component through the coupling.

In some embodiments of the present disclosure, a stroke of the cutter bar component extending translationally towards the station space is defined as a cutter bar pushing stroke of the cutter bar component, a size of the protection component along the central axis direction of the cutter bar component is defined as a total protection length of the protection component, and the cutter bar pushing stroke is less than the total protection length of the protection component.

The present disclosure further provides a paperboard cutting system, including:

the paperboard cutting device described above;

an overload protection device configured to monitor an operating state of the cutter bar component of the paperboard cutting device; and

a master control module, where both the driving component of the paperboard cutting device and the overload protection device are electrically connected to the master control module.

In summary, the paperboard cutting device and the paperboard cutting system provided by the present disclosure have the following technical effects.

By utilizing the station space defined between the protection component and the housing component for paper feeding, as well as the driving component, the linear transmission mechanism and the cutter bar component enclosed in the housing component, the function of cutting paper as required by the child is achieved and safety measures are provided. In this way, it can not only prevent the accidental contact with the driving component, the linear transmission mechanism and the cutter bar component during the operation process, but also prevent the fingers of the child from extending into the station space which accommodates the thickness of the paper, thereby achieving good safety performance, which is simple and convenient to use, and is conducive to the independent operation of the child without the continuous supervision and assistance of adults, thereby being conducive to cultivating the independent operation ability and manual ability of the child.

### BRIEF DESCRIPTION OF DRAWINGS

FIG. 1 is an overall structural diagram of a paperboard cutting device according to an embodiment of the present disclosure.

FIG. 2 is a partial assembly diagram of a paperboard cutting device according to an embodiment of the present disclosure.

FIG. 3 is a partial enlarged view of part A shown in FIG. 2.

FIG. 4 is a schematic top view of a paperboard cutting device according to an embodiment of the present disclosure.

FIG. 5 is a full sectional view taken along line B-B shown in FIG. 4.

FIG. 6 is a partial enlarged view of part C shown in FIG. 5.

### DESCRIPTION OF REFERENCE NUMBERS

1-driving component; 2-linear transmission mechanism; 21-push rod member; 211-transmission inner cavity; 22-transmission component; 23-guide component; 231-first guide member; 232-second guide member; 3-cutter bar component; 4-housing component; 41-housing inner cavity; 42-cutting station surface; 43-housing side wall; 44-housing top wall; 5- protection component; 51-protection base; 52-protection cover; 53-protection connector; 6-station space; 7-coupling.

### DETAILED DESCRIPTION

For better understanding and implementation, technical solutions in embodiments of the present disclosure will be described clearly and completely below in conjunction with accompanying drawings of the embodiments of the present disclosure.

In the description of the present disclosure, it should be noted that the terms, such as “upper”, “lower”, “front”, “rear”, “left”, “right”, “vertical”, “horizontal”, “top”, “bottom”, “inside”, “outside”, and the like, indicating the orientation or positional relationship are based on the orientations or positional relationships shown in the accompanying drawings, and they are only used to facilitate the description of the present disclosure and simplify the description, but not to indicate or imply that the referred device or element must have a specific orientation, be constructed and operated in a specific orientation, and therefore cannot be understood as a limitation to the present disclosure.

Unless otherwise defined, all technical and scientific terms used herein have the same meaning as those commonly understood by one of ordinary skill in the art to which the present disclosure belongs. The terms used in the specification of the present disclosure herein are only for the purpose of describing specific embodiments, and are not intended to limit the present disclosure.

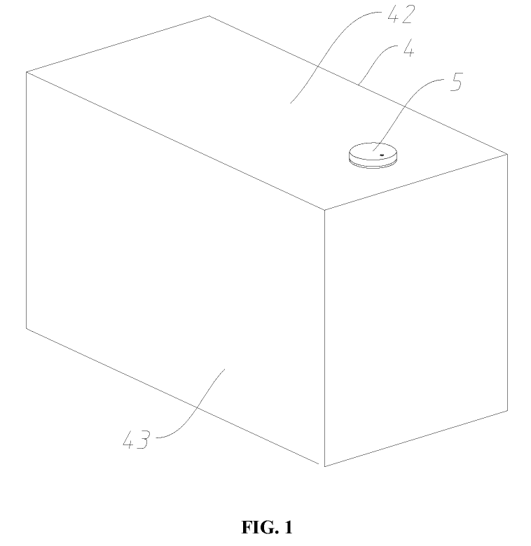

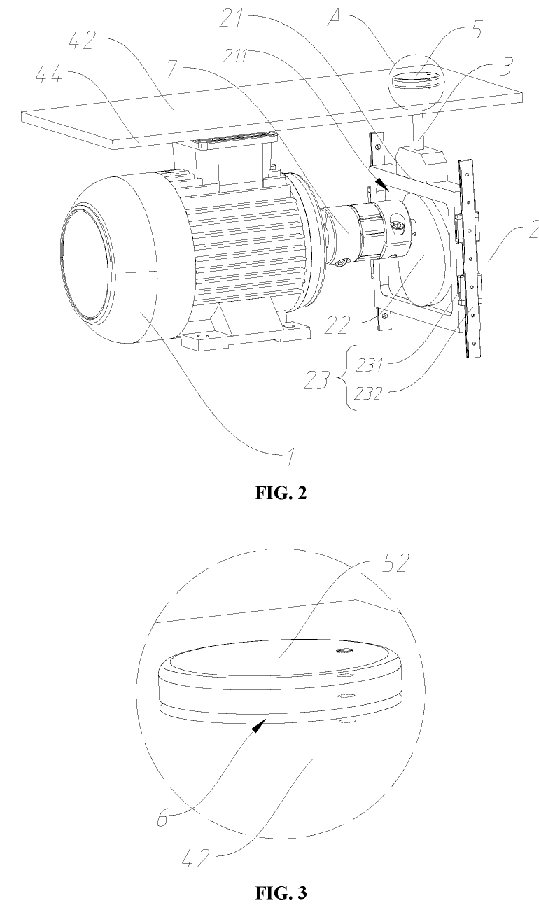

Specifically, referring to FIG. 1 and FIG. 2, the present disclosure provides a paperboard cutting device, including a driving component 1, a linear transmission mechanism 2, a cutter bar component 3 and a housing component 4. In some embodiments, the driving component 1 is a driving motor. The housing component 4 includes a housing side wall 43, a housing top wall 44 and a housing bottom wall for abutting against a support surface, and the support surface includes but is not limited to a ground surface, a table surface, a countertop and a machining datum plane. The housing top wall 44 and the housing bottom wall are arranged oppositely, the housing side wall 43 is located between the housing top wall 44 and the housing bottom wall, and the housing side wall 43 extends along a circumferential direction of the housing bottom wall. The housing top wall 44, the housing bottom wall and the housing side wall 43 cooperate to define a housing inner cavity 41 inside the housing component 4.The cutter bar component 3, the driving component 1 and the linear transmission mechanism 2 are all installed in the housing inner cavity 41, so that during the operation of the paperboard cutting device, an operator, especially a child, will not come into contact with the cutter bar component 3, the driving component 1 and the linear transmission mechanism 2, thereby ensuring the use safety and comfort of the operator and the child.

It can be understood that the paperboard cutting device is not limited to be applied to flexible or hard paperboard, for example, the paperboard cutting device can also be used to cut materials such as tin foil, aluminum film, or the like. The housing component 4 may include a rigid, transparent non-metallic material (such as glass, acrylic, etc.) to facilitate the observation and learning of internal components by children, and may also include a metallic material.

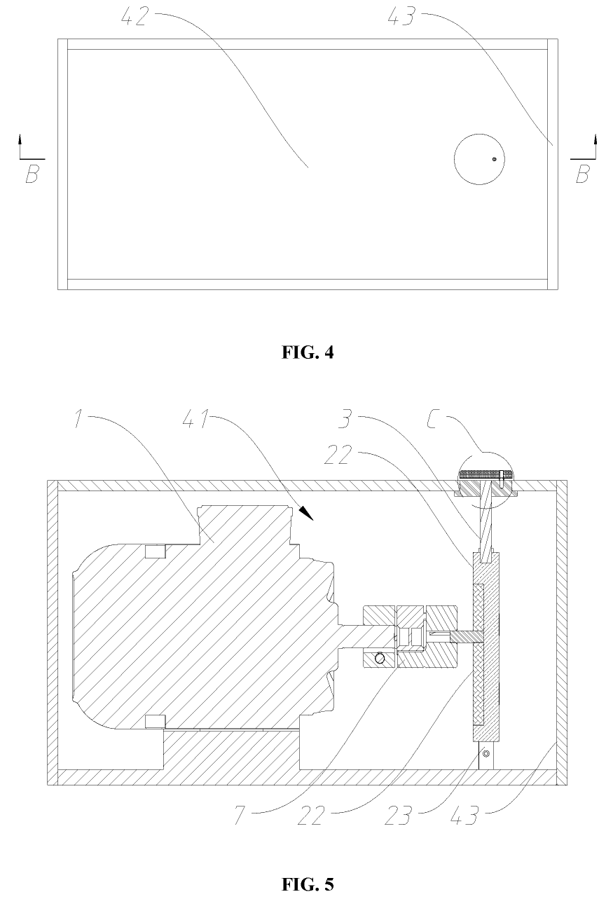

In some embodiments, and with specific reference to FIG. 1, FIG. 2, FIG. 4 and FIG. 5, the driving component 1 is drivably connected to an input portion of the linear transmission mechanism 2, and the cutter bar component 3 is fixedly mounted on an output portion of the linear transmission mechanism 2, so that the driving component 1 delivers a rotation torque to the input portion of the linear transmission mechanism 2, and the linear transmission mechanism 2 converts the rotation torque provided by the driving component 1 into a linear motion and transmits the linear motion to the cutter bar component 3, enabling the cutter bar component 3 to perform reciprocating linear motion.

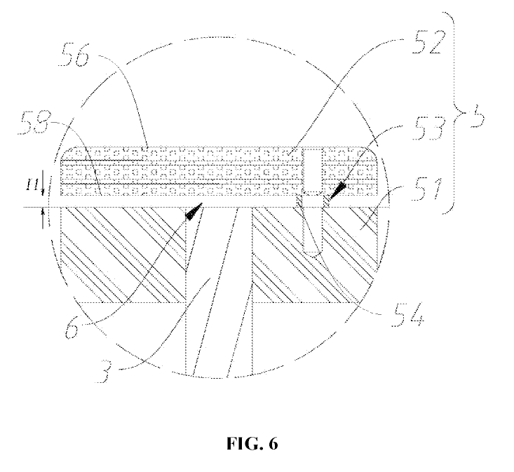

Further, with specific reference to FIG. 1, FIG. 3, and FIG. 6, an outer top surface of the housing top wall 44 is configured as a cutting station surface 42 on the housing component 4, to facilitate placement and pushing of a paperboard by a user. For example, the user may be a child. A protection component 5 is disposed on the cutting station surface 42 on the housing component 4. In some embodiments, as shown in FIG. 6, the protection component 5 may include a protection base 51 and a protection cover 52. The protection cover 52 includes an upper surface 56 and a lower surface 58. Referring to FIG. 3 and FIG. 6, a station space 6 is defined between the cutting station surface 42 and the lower surface 58 of the protection cover 52 of the protection component 5. The cutter bar component 3 passes through the protection base 51 of the protection component 5, and the cutting edge end of the cutter bar component 3 is driven by the linear transmission mechanism 2 to protrude from the protection base 51 of the protection component 5 and extend into the station space 6 for cutting of the paperboard, as well as to retract back to the inside of the protection base 51 of the protection component 5, so as to prevent the operator's finger from being cut by the cutting edge end of the cutter bar component 3 when the operator's finger reaches into the station space 6, thereby ensuring and improving the operational safety of the paperboard cutting device. The “cutting” may include but are not limited to the actions of cutting, nibbling, blanking and processing paperboard or paper.

In some embodiments, a paperboard cutting device may include a driving component; a linear transmission mechanism, drivably connected to an input portion of the linear transmission mechanism; a cutter bar component fixedly mounted on an output portion of the linear transmission mechanism; a housing component having a housing inner cavity; a protection component disposed on a the housing component, wherein the protection component having a protection cover positioned above a cutting station surface. The cutter bar component, the driving component, and the linear transmission mechanism are all mounted in the housing inner cavity. A length of the cutter bar component is configured such that, at a maximum extension, a tip of a cutting edge end of the cutter bar component is positioned under the protection cover. In some embodiments, a movement of the cutter bar component is controlled such that, at a maximum extension, a tip of a cutting edge end of the cutter bar component is positioned under the lower surface of the protection cover.

Referring to FIG. 3 and FIG. 6, along a central axis direction of the cutter bar component 3, a distance between the cutting station surface 42 and the lower surface 58 of the protection cover 52 of the protection component 5 is defined as a cutting thickness H of the station space 6. In some embodiments, the cutting thickness H ranges from 1.5 mm to 3 mm.

When the cutting thickness H is less than 1.5 mm, the cutting thickness H is too small, which is not convenient to quickly feed the paperboard to the station space 6 for cutting. In addition, when the cutting thickness H is too small, friction is generated between the paperboard and the cutting station surface 42 as well as between the paperboard and the protection component 5 when the paperboard is fed to the station space 6, which is prone to cause wrinkling of the surface of the paperboard and impair the cutting effect of the paperboard. On the other hand, when the cutting thickness H is greater than 3 mm, the cutting thickness H is large, which not only easily causes the risk that a part of the finger tip of the child reaches into the station space 6 to cause the finger tip to be cut by the cutting edge end of the cutter bar component 3, but also raises the risk that the child mistakenly feeds the thick board into the station space 6 to damage the paperboard cutting device.

The cutting thickness H of the station space 6 ranges from 1.5 mm to 3 mm, which can not only effectively ensure good safety performance of the paperboard cutting device during operation, but also ensure the stability of the paperboard cutting device during cutting of the paperboard, thereby improving the service life of the paperboard cutting device. Preferably, the cutting thickness H is 2 mm, 2.2 mm, or 2.5 mm.

In some embodiments, specifically referring to FIG. 2, FIG. 3, FIG. 5 and FIG. 6, the protection component 5 described above includes a protection base 51 and a protection cover 52 arranged outside the housing component 4, and the protection cover 52 may include rigid plastic or metallic material. The material of the protection base 51 is preferably high-strength wear-resistant metal to ensure increased service life. The protection cover 52 is connected to the protection base 51, and the protection base 51 is fixedly connected to the housing component 4. Specifically, the housing top wall 44 of the housing component 4 is provided with a base mounting opening, the shape and size of the base mounting opening are adapted to the shape and size of the protection base 51, the protection base 51 is embedded in the base mounting opening, and the protection base 51 may be connected to the housing top wall 44 by fasteners (such as bolts, nuts, and screws). For example, the protection base 51 is close to the housing top wall 44.In some embodiments, the protection base 51 may be welded to the housing top wall 44. To ensure that the paperboard can be stably and smoothly fed into the station space 6, the plane of the protection base 51 close to the cutting station surface 42 is preferably flush with the cutting station surface 42. As shown in FIG. 6, the protection cover 52 includes an upper surface 56 and a lower surface 58.

Further, as shown in FIG. 2, FIG. 5 and FIG. 6, the protection base 51 is provided with a cutter bar through hole, the aperture of the cutter bar through hole is preferably adapted to the diameter of the cutter bar component 3, or, within the assembly tolerance range, and the aperture of the cutter bar through hole is greater than the diameter of the cutter bar component 3, enabling the cutter bar component 3 to pass through the protection base 51 and perform reciprocating linear motion. It can be understood that the inner hole wall of the cutter bar through hole and the surface of the cutter bar component 3 are machined to specific fitting size and subjected to smoothing treatment, which ensures the accuracy and stability of the cutting process. In some embodiments, the station space 6 is defined between the lower surface 58 of the protection cover 52 and the cutting station surface 42, and the cutter bar component 3 passes through the cutter bar through hole and can extend into the station space 6 to cut the paperboard in the station space 6.

In some embodiments, specifically referring to FIG. 5 and FIG. 6, the protection component 5 further includes a protection connector 53. The protection connector 53 is disposed at a side of the cutter bar component 3, and the protection cover 52 is connected to the protection base 51 through the protection connector 53. Each of the protection cover 52 and the protection base 51 includes a hole configured for passing through of the protection connector 53. In one example, the protection connector 53 includes a support sleeve 54 sandwiched between the protection cover 52 and the protection base 51, and a connecting fastener. The connecting fastener may be a bolt, a screw, or a stud. During installation, the connecting fastener sequentially passes through the protection cover 52 and the support sleeve 54 of the protection connector 53, and then is threadedly connected to the protection base 51, thereby achieving the connection between the protection cover 52 and the protection base 51 through the protection connector 53.

In some embodiments, the protection cover 52 and the support sleeve 54 are integrally formed, for example, by injection molding to facilitate disassembly and assembly of the paperboard cutting device.

In some embodiments, the support sleeve of the protection connector 53 and the protection cover 52 are separate components, and the cutting thickness H between the cutting station surface 42 and the lower surface 58 of the protection cover 52 of the protection component 5 can be adjusted by replacing the support sleeve. In some examples, the protection connector includes a replaceable support sleeve disposed between the protection cover and the protection base, and a connecting fastener. A height of the replaceable support sleeve defines a cutting thickness H of the station space and the cutting thickness H of the station space can be adjusted by using support sleeves with different heights. For example, a paperboard cutting device is provided with a set of support sleeves and each support sleeve has different heights. A user can select a sleeve with a height corresponding to a thickness of paperboard to be cut.

In some embodiments, a side of the cutter bar component 3 close to the station space 6 is configured with a cutting surface, and a peripheral edge of the cutting surface is configured as a cutting edge end of the cutter bar component 3, that is, the cutter bar component 3 is a blunt-type cutter bar with a blunt-type cutter segment along a length of the cutter bar component, which not only facilitates the machining and manufacturing the cutter bar component 3, but also, more importantly, enables the paperboard cutting device to avoid the risk of scratching an operator (especially a child) during the process of cutting the paperboard or the process of disassembling and assembling the paperboard cutting device, thereby more effectively enhancing the safety performance of the paperboard cutting device.

The cutter bar component 3 is driven by the linear transmission mechanism 2 during the process of cutting the paperboard, the cutter bar component 3 moves relative to the protection base 51 along the central axis direction of the cutter bar component 3, and extends into the station space 6, creating an offset between the cutting surface and the cutting station surface 42, thereby achieving the processing purpose of cutting, blanking and nibbling the paperboard.

In some embodiments, after the cutter bar component 3 extends into the station space 6, the cutting surface of the cutter bar component 3 may abut against and contact the protection cover 52, to complete cutting, blanking and nibbling of the paperboard. For example, the lower surface 58 of the protection cover 52 is a flat surface as shown in FIG. 6.

In some embodiments, the protection cover is provided with a cutter positioning space along the central axis direction of the cutter bar component 3. In one embodiment, the cutter positioning space may be of a through hole structure passing through the protection cover (not shown), and the center of the through hole structure is substantially aligned with the central axis direction. In another embodiment, the cutter positioning space may be a recessed structure recessed from the lower surface of the protection cover (not shown). The center of the recessed structure is substantially aligned with the central axis direction. The diameter of the cutter positioning space is adapted to the diameter of the cutter bar component 3, or, within an assembly tolerance range, and the diameter of the cutter positioning space may be greater than the diameter of the cutter bar component 3. Thus, when the cutter bar component 3 extends into the station space 6, the cutting edge end of the cutter bar component 3 is inserted into the cutter positioning space.

In the embodiments of protection cover having the cutter positioning space, the cutter positioning space provides a buffer space for the cutter bar component 3, avoiding a collision phenomenon caused when the cutter bar component 3 directly abuts against the protection cover 52, thereby preventing the cutter bar component 3 from damaging the protection cover 52. During the extension of the cutting edge end of the cutter bar component 3 into the cutter positioning space, relative sliding occurs between the cutting edge end of the cutter bar component 3 and the cutter positioning space, that is, the cutter positioning space can effectively guide the sliding of the cutting edge end of the cutter bar component 3, so that the vibration generated by the cutter bar component 3 during the cutting, blanking and nibbling process can be reduced, and the stability of the cutting, blanking and nibbling process for the paperboard is improved.

In some embodiments, the protection component 5 further includes a protection shell disposed around the outer side of the protection cover 52, the material of the protection shell herein optionally includes transparent high-strength plastic, and the protection shell is provided with a feed conveying port communicated with the station space 6 to ensure that the paperboard can be fed to the station space 6 through the feed conveying port for cutting. It can be understood that along the central axis direction of the cutter bar component 3, the distance between the cutting station surface 42 and the lower surface 58 of the protection cover 52 of the protection component 5 is greater than or equal to the width of the feed conveying port. That is, through the constraint of the feed conveying port of the protection shell, the following technical effects are achieved.

1. The size of the paperboard that can pass through the feed conveying port can be effectively limited, thereby preventing a child from mistakenly feeding an excessively thick paperboard into the station space 6 for forcible processing, and improving the service life of the paperboard cutting device.

2. Constrained by the width of the feed conveying port and with an appropriate increase in the distance from the feed conveying port to the cutter bar component 3, the risk of a child mistakenly inserting a finger into the station space 6 is significantly reduced or even eliminated, further improving the operational safety of the paperboard cutting device.

3. The assembly precision between the cutting station surface 42 and the protection component 5 and the processing precision of the protection component 5 are effectively reduced, thereby reducing the production requirements and assembly difficulty of the paperboard cutting device. In addition, the thickness of the paperboard that can enter the station space 6 for processing can be restricted by replacing the protection shell, which further improves the convenience and efficiency of adjustment, thereby improving the operation experience of the paperboard cutting device.

Referring to FIG. 2, FIG. 4 and FIG. 5, in some embodiments, the linear transmission mechanism 2 may include a push rod member 21. The push rod member 21 serves as an output portion of the linear transmission mechanism 2, the cutter bar component 3 is fixedly connected to the push rod member 21, and the push rod member 21 is drivably connected to the driving end of the driving component 1, so that the driving end of the driving component 1 drives the push rod member 21 to perform reciprocating linear motion, thereby driving the cutter bar component 3 to perform reciprocating linear motion to achieve the purpose of cutting, blanking or nibbling the paperboard.

Continuing with FIG. 2, FIG. 4 and FIG. 5, the linear transmission mechanism 2 includes a transmission component 22 and a guide component 23, the direction of movement guided by the guide component 23 is consistent with the central axis direction of the cutter bar component 3, the push rod member 21 is slidably connected to the guide component 23, the transmission component 22 is drivably connected to the push rod member 21, the transmission component 22 is detachably connected to the driving end of the driving component 1, and the guide component 23 is fixedly connected to the housing component 4.

With this arrangement, the driving component 1 provides power, and then the power is transmitted to the push rod member 21 through the transmission component 22, driving the push rod member 21 to perform reciprocating linear motion along the direction of movement guided by the guide component 23, thereby stably driving the cutter bar component 3 fixedly connected to the push rod member 21 to perform reciprocating linear motion, and achieving the purpose of cutting, blanking and nibbling the paperboard.

Referring to FIG. 2 and FIG. 5, the push rod member 21 is provided with a transmission inner cavity 211, the transmission component 22 is mounted inside the transmission inner cavity 211, and the push rod member 21 covers at least a part of the transmission component 22. In some embodiments, the push rod member 21 include a frame configured to surround a moving path of the transmission component 22 to block a touch of an object with the transmission component. In the illustrated example, the moving path is a rotation path. In one example, a rectangular frame or a square for the transmission component 22 to positioned inside the frame. As the frame surrounds a moving path, the configuration can avoid the risk that the child accidentally touches the transmission component 22 during the process of assembling the paperboard cutting device and/or during the operation of the paperboard cutting device, thereby achieving the purpose of double protection in conjunction with the housing component 4.

In some embodiments, specifically referring to FIG. 2, the transmission component 22 described above is a cam member, the cam member serves as an input portion of the linear transmission mechanism 2, a circumferential curved surface of the cam member abuts against a first inner cavity surface of the transmission inner cavity 211, and the first inner cavity surface refers to a side surface of the transmission inner cavity 211 close to the cutter bar component 3. Thus, the cam member cooperates with the push rod member 21 to form a cam transmission mechanism, and the cam member is connected to the driving component 1. In this way, by using the cam drive principle, the rotary motion of the cam member drives the follower (i.e., the push rod member 21) to perform specified reciprocating motion, which is not only simple and compact in structure, but also enables accurate realization of the desired motion. As long as the profile curve of the cam is appropriately designed, various expected movements can be obtained for the push rod.

In other embodiments, the transmission component 22 described above includes a crank member and a connecting rod member, the crank member serves as the input portion of the linear transmission mechanism 2, the crank member is connected to the push rod member 21 through the connecting rod member, and the crank member is connected to the driving component 1. That is, one end of the crank member is fixedly connected to the driving end of the driving component 1, the other end of the crank member is hinged to one end of the connecting rod member, and the other end of the connecting rod member is hinged to the push rod member 21. Thus, the crank member, the connecting rod member and the push rod member 21 together form a crank slider mechanism, and the purpose of converting the rotational torque provided by the driving component 1 into the reciprocating linear motion of the push rod member 21 can also be achieved.

In other embodiments, the transmission component 22 includes a rotating body member and a translating body member, the translating body member is engaged or meshed with the rotating body member, the rotating body member serves as the input portion of the linear transmission mechanism 2, the translating body member is connected to the push rod member 21, and the translating body member is connected to the driving component 1. For example, the rotating body member may be a gear, and the translating body member corresponds to a rack meshing with the gear. In some embodiments, the rotating body member may be a worm gear, and the translating body member corresponds to a worm engaged with the worm gear. Thus, the rotating body member cooperates with the translating body member to form a gear and rack transmission mechanism or a worm gear and worm transmission mechanism, achieving the purpose of converting the rotational torque provided by the driving component 1 into the reciprocating linear motion of the push rod member 21, and the transmission component 22 has a large transmission ratio and a compact structure. Meanwhile, the transmission is stable and noise-free.

In other embodiments, the driving end of the driving component may be directly connected to the push rod member, and the push rod member is driven by the driving component 1 to perform linear motion, and the driving component is a linear motor, a cylinder, a hydraulic cylinder, an electric cylinder, or other electrical components capable of performing linear reciprocating motion. In this embodiment, the push rod member may include a frame configured to surround a moving path of the driving component to block a touch of an object with the driving component. The moving path is a linear movement of the driving component.

In some embodiments, the guide component 23 described above includes a first guide member 231 and a second guide member 232. The second guide member 232 is provided with a guide hole into which the first guide member 231 is inserted. The extension direction of the first guide member 231 is consistent with the central axis direction of the cutter bar component 3, and the first guide member 231 and the second guide member 232 are slidably connected with each other. The first guide member 231 is disposed on the push rod member 21, and the second guide member 232 is disposed on the housing component 4. That is, the first guide member 231 is configured as a slider, and the second guide member 232 is configured as a fixed guide rod/slide rail slidably connected to the slider. In other embodiments, the first guide member 231 may be disposed on the housing component 4, and the second guide member 232 may be correspondingly disposed on the push rod member 21. That is, the first guide member 231 is configured as a sliding guide rod, and the second guide member 232 is configured as a fixed sliding seat. This arrangement not only ensures that the translation of the push rod member 21 is smoother and more stable, but also ensures that the movement precision of the cutter bar component 3 is higher, thereby effectively improving the processing precision of the paperboard cutting device.

It should also be noted that the stroke of the cutter bar component 3 extending translationally towards the station space 6 is defined as the cutter bar pushing stroke of the cutter bar component 3, the length of the protection component 5 along the central axis direction of the cutter bar component 3 is the total protection length of the protection component 5. The length of the protection component 5 is determined from the upper surface of the protection cover to a bottom surface of the protection base. The cutter bar pushing stroke is smaller than the total protection length of the protection component 5. It can be understood that the cutter bar pushing stroke is greater than or equal to the cutting thickness H of the station space 6 to ensure that the cutter bar component 3 can fully and completely cut the paperboard.

In this way, for example, when the cutter positioning space is of a through hole structure, the cutter bar pushing stroke is less than the total protection length of the protection component 5, which can ensure that the cutter bar component 3 does not penetrate through and extend out of the through hole structure, avoid the risk of injury to children caused by the fact that the cutting edge end of the cutter bar component 3 extend out of the through hole, and also prevent the hair of children or other articles from being caught into the through hole structure, thereby further improving the operational safety of the paperboard cutting device. For example, when the cutter positioning space is of a recessed structure, the problem that the cutter bar component 3 and the protection component 5 are damaged due to the cutting edge end of the cutter bar component 3 abutting against the wall of the recessed structure can be avoided.

In some embodiments, the cutter bar component is configured to, by being driven by the linear transmission mechanism, pass through the cutter bar through hole of the protection base and extend into the station space, and wherein a movement of the cutter bar component is controlled such that, at a maximum extension, a tip of a cutting edge end of the cutter bar component is positioned under the lower surface of the protection cover.

In some embodiments, specifically referring to FIG. 2 and FIG. 5, the paperboard cutting device further includes a coupling 7, and the coupling 7 herein is a torque limiting coupling 7. When the overload or mechanical failure causes the required torque to exceed the set value, it limits the torque transmitted by the transmission system in the form of slipping and can simultaneously output a signal to stop the driving component 1, and restore the connection by itself when the overload condition disappears. With such an arrangement, in cooperation with the driving component 1, it can be effectively ensured that the cutting device can only cut a paperboard with a thickness within a certain range, such as 2 mm, and cannot cut a harder or thicker materials, thereby preventing the driving component 1 from being stuck and damaged due to the child inserting materials that are too hard, and achieving the purpose of avoiding high-risk operations.

Here, the use of the coupling 7 can also realize the detachable connection between the driving component 1 and the linear transmission mechanism 2, so that the driving component 1, the coupling 7 and the linear transmission mechanism 2 can be independently disassembled and replaced, which can not only facilitate maintenance, but also facilitate subsequent upgrade and function expansion.

Based on the structure and connection relationship of the above paperboard cutting device, a paperboard cutting system is provided. The paperboard cutting system comprises paperboard cutting device as described above, an overload protection device, and a master control module, the overload protection device is used for monitoring the operation state of the cutter bar component 3, and the driving component 1 of the paperboard cutting device and the overload protection device are both electrically connected to the master control module. In some embodiments, in response to a detection that, for a preset time, the cutter bar component does not move and/or the driving component does not rotate, the master control module controls the driving component to stop an operation, and alerts a user through a color change of an indicator light of or through a sound alarm.

In this way, when the child mistakenly feeds the paperboard with higher hardness into the station space 6 of the paperboard cutting device, resulting in that the cutter bar component 3 cannot be processed, the overload protection device can timely detect that the cutter bar component 3 cannot move and/or the driving component 1 cannot rotate, and generate a monitoring signal to be transmitted to the master control module. The master control module receives the monitoring signal and sends a control instruction to the driving component 1 to control the driving component 1 to stop providing the rotational torque (stop operating), ensuring that the cutter bar component 3 and the driving component 1 are not damaged, and can also alert the user through an indicator light of color change and sound alarm, thereby further improving the service life and operational safety of the paperboard cutting device and preventing potential safety hazards.

The technical means disclosed in the present disclosure are not limited to the technical means disclosed in the above embodiments, but also include technical solutions formed by any combination of the above technical features. It should be noted that for those of ordinary skill in the art, several improvements and modifications can be made without departing from the principle of the present disclosure, and these improvements and modifications are also considered to be within the protection scope of the present disclosure.

1. A paperboard cutting device, comprising:
a driving component;
a linear transmission mechanism, wherein the driving component is drivably connected to an input portion of the linear transmission mechanism;
a cutter bar component, fixedly mounted on an output portion of the linear transmission mechanism;
a housing component having a housing inner cavity, wherein an outer top surface of a housing top wall is configured as a cutting station surface; and
a protection component disposed on a the housing component, wherein the protection component includes a protection base and a protection cover, wherein the protection base includes a cutter bar through hole, and is positioned on the housing top wall of the housing component, and wherein the protection cover has an upper surface and a lower surface, and is arranged outside the housing component and above the cutting station surface, wherein a station space is defined between the cutting station surface and the lower surface of the protection cover,
wherein the cutter bar component, the driving component, and the linear transmission mechanism are mounted in the housing inner cavity, and
wherein the cutter bar component is configured to, by being driven by the linear transmission mechanism, pass through the cutter bar through hole of the protection base and extend into the station space, and wherein a movement of the cutter bar component is controlled or a length of the cutter bar component is configured such that, at a maximum extension, a tip of a cutting edge end of the cutter bar component is positioned under the lower surface of the protection cover.

2. The paperboard cutting device according to claim 1, wherein the protection component comprises a protection connector disposed at a side of the cutter bar component, wherein the protection cover is connected to the protection base through the protection connector, wherein the protection connector includes a replaceable support sleeve disposed between the protection cover and the protection base and a connecting fastener, and wherein a height of the replaceable support sleeve defines a cutting thickness of the station space.

3. The paperboard cutting device according to claim 2, wherein a side of the cutter bar component close to the station space is configured with a cutting surface, and a peripheral edge of the cutting surface is configured as the cutting edge end of the cutter bar component .

4. The paperboard cutting device according to claim 1, wherein along a central axis direction of the cutter bar component, a distance between the cutting station surface and the lower surface of the protection cover is defined as a cutting thickness of the station space, and the cutting thickness ranges from 1.5 mm to 3 mm.

5. The paperboard cutting device according to claim 1, wherein the linear transmission mechanism comprises a push rod member , the push rod member serves as the output portion of the linear transmission mechanism, the cutter bar component is fixedly connected to the push rod member, and the push rod member is drivably connected to a driving end of the driving component .

6. The paperboard cutting device according to claim 5, wherein the linear transmission mechanism further comprises a transmission component, the transmission component is drivably connected to the push rod member, and the transmission component is detachably connected to the driving end of the driving component.

7. The paperboard cutting device according to claim 6, wherein the push rod member comprises a frame configured to surround a moving path of the transmission component.

8. The paperboard cutting device according to claim 7, wherein the push rod member comprises a transmission inner cavity, and the transmission component is mounted in the transmission inner cavity, wherein the transmission component comprises a cam member, the cam member serves as the input portion of the linear transmission mechanism, a circumferential curved surface of the cam member abuts against a first inner cavity surface of the transmission inner cavity, the first inner cavity surface is a side surface of the transmission inner cavity close to the cutter bar component, and the cam member is connected to the driving component.

9. The paperboard cutting device according to claim 6, wherein the transmission component comprises a crank member and a connecting rod member, the crank member serves as the input portion of the linear transmission mechanism, the crank member is connected to the push rod member through the connecting rod member, and the crank member is connected to the driving component.

10. The paperboard cutting device according to claim 6, wherein the transmission component comprises a rotating body member and a translating body member, the translating body member is engaged with or meshed with the rotating body member, the rotating body member serves as the input portion of the linear transmission mechanism , the translating body member is connected to the push rod member, and the translating body member is connected to the driving component.

11. The paperboard cutting device according to claim 6, wherein the linear transmission mechanism further comprises a guide component, a direction of movement guided by the guide component is consistent with a central axis direction of the cutter bar component, the push rod member is slidably connected to the guide component , and the guide component is fixedly connected to the housing component.

12. The paperboard cutting device according to claim 11, wherein the guide component comprises a first guide member and a second guide member, the second guide member is provided with a guide hole into which the first guide member is inserted, an extension direction of the first guide member is consistent with the central axis direction of the cutter bar component, and the first guide member and the second guide member are slidably connected with each other; and
wherein one of the first guide member and the second guide member is disposed on the push rod member, and another one of the first guide member and the second guide member is disposed on the housing component.

13. The paperboard cutting device according to claim 6, further comprising a coupling, wherein the transmission component is connected to the driving end of the driving component through the coupling .

14. A paperboard cutting device, comprising:
a driving component;
a linear transmission mechanism, wherein the driving component is drivably connected to an input portion of the linear transmission mechanism;
a cutter bar component fixedly mounted on an output portion of the linear transmission mechanism;
a housing component having a housing inner cavity, wherein an outer top surface of a housing top wall is configured as a cutting station surface; and
a protection component disposed on a the housing component, wherein the protection component includes a protection base and a protection cover, wherein the protection base includes a cutter bar through hole, and is positioned on the housing top wall of the housing component, and wherein the protection cover has an upper surface and a lower surface, and is arranged outside the housing component and above a cutting station surface, wherein a station space is defined between the cutting station surface and the lower surface of the protection cover;
wherein the cutter bar component, the driving component, and the linear transmission mechanism are mounted in the housing inner cavity, and
wherein the cutter bar component is configured to, by being driven by the linear transmission mechanism, pass through the cutter bar through hole of the protection base and extend into the station space to cut a paperboard.

15. The paperboard cutting device according to claim 14, wherein the lower surface of the protection cover is a flat surface.

16. The paperboard cutting device according to claim 14, wherein along a central axis direction of the cutter bar component, the protection cover is configured to have a cutter positioning space, and a cutting edge end of the cutter bar component is capable of being inserted into the cutter positioning space when driven by the linear transmission mechanism.

17. The paperboard cutting device according to claim 16, wherein the cutter positioning space is a through hole on the protection cover.

18. The paperboard cutting device according to claim 16, wherein the cutter positioning space is a recessed structure recessed from the lower surface of the protection cover.

19. A paperboard cutting system, comprising:
a paperboard cutting device, wherein the paperboard cutting device comprises:
a driving component;
a linear transmission mechanism, wherein the driving component is drivably connected to an input portion of the linear transmission mechanism;
a cutter bar component, fixedly mounted on an output portion of the linear transmission mechanism;
a housing component having a housing inner cavity;
a protection component disposed on a the housing component, wherein the protection component includes a protection base and a protection cover, wherein the protection base includes a cutter bar through hole, and is positioned on a housing top wall of the housing component, and wherein the protection cover has an upper surface and a lower surface, and is arranged outside the housing component and above a cutting station surface, wherein a station space is defined between the cutting station surface and the lower surface of the protection cover,
wherein the cutter bar component, the driving component, and the linear transmission mechanism are mounted in the housing inner cavity, and
wherein the cutter bar component is configured to, by being driven by the linear transmission mechanism, pass through the cutter bar through hole of the protection base and extend into the station space to cut a paperboard;
an overload protection device configured to monitor an operating state of the cutter bar component of the paperboard cutting device; and
a master control module, wherein both the driving component of the paperboard cutting device and the overload protection device are electrically connected to the master control module,
wherein, in response to a detection that, for a preset time, the cutter bar component does not move and/or the driving component does not rotate, the master control module controls the driving component to stop an operation, and alerts a user through a color change of an indicator light of or through a sound alarm.
